(19) United States
(12) Patent Application Publication
(10) Pub. No.: US 2022/0358283 A1
(43) Pub. Date: Nov. 10, 2022

(54) COMPUTER IMPLEMENTED COGNITIVE FUNCTIONING SYSTEM

(71) Applicant: Pablo Tomas Borda, Dublin (IE)

(72) Inventor: Pablo Tomas Borda, Dublin (IE)

(21) Appl. No.: 17/675,691

(22) Filed: Feb. 18, 2022

Related U.S. Application Data
(60) Provisional application No. 63/186,229, filed on May 10, 2021.

(51) Int. Cl. G06F 40/174; G06F 9/445; G06V 10/44

(52) U.S. Cl. CPC G06F 40/174; G06F 9/44526; G06V 10/44

(57) ABSTRACT

This present system relates to providing people with a unique and non-invasive approach to improve people's cognitive function. The invention can be implemented as a software/application or a system. The invention used a combination of computer vision, artificial intelligence, and augmented reality components. The invention offers a layer of cognitive processing in real-time thus, improving people's intelligence and merging with artificial intelligence. The invention provides a virtual transparent glass over the information displayed on a display with parsed information. The invention eliminates software integrations, Software Engineering design patterns, and minimizes the required user input to a system.

### CROSS-REFERENCE TO RELATED APPLICATION

This application claims the benefit and takes the priority from the U.S. Provisional Utility Patent Application No. 63/186,229 filed on May 10, 2021, the contents of which are herein incorporated by reference.

### BACKGROUND

Current software does not amplify a person's mind capabilities complementing your own subjective thought processing, and does not provide cognitive support in their everyday life. People need to solve problems, study, remember usernames, passwords, verifications, information for filling forms for the school, job applications, for buying an air ticket, shopping carts, government tax forms or the like.

Most of the interaction with computers today relate to third-person software (yourself asking something to somebody else mostly using forms) instead of our unique first-person software approach. Filling in forms can be very often challenging and time consuming. For example, some of the forms may require providing detailed information. Such detailed information may include name, tax data, account numbers, and customer identification numbers, and may not be readily available or remembered by a user. Furthermore, some of the forms may require inserting the same information over and over again. Further, the forms filled in manually may include typographical errors, and some data fields may be mistakenly omitted.

In the case of an Agent such as customer care agents have to follow a lot of steps on their portals to resolve a customer's query which lead to a time consuming and cumbersome process. An agent may need to login to an admin portal, billing system portal and have to manually write or copy and paste essential information such as customer's account number, remaining payment etc. from a source such as customer's complaint email. It is desired to have relevant information auto-filled by scanning the email of the customer.

Also, a user has to interact with various third-person software and applications and need to carry various devices or software which are not compatible to each other and cannot be easily integrated. It is desired to have a technology that does not rely on integrations and is able to interact with any device.

Some systems and technologies rely on software integrations using software engineering design patterns and the systems or devices implementing such integrations are not self-aware and do not know the outcome of the ongoing processes.

Current systems do not understand the cognitive approach of the user and do not provide an effective solution. For example, in some techniques, previous entries in a form can be remembered but only if the form is identical to the previous form. This causes waste of time and effort if a new type of form is to be filled by a user.

Also, current systems use Artificial intelligence (AI) to provide convenience to a user, however, AI alone is ineffective and need to be combined with other computer technologies to cognitive processing to current system and software.

Therefore, there exists a long felt need in the art for system and technology that detect information from the real world and enable automation from a first-person subjective approach preempting possible user input and displaying solutions on real time before the question is made. There is also a long felt need in the art for system and technology that make the concept of software integrations obsolete. Additionally, there is a long felt need in the art for system and technology that minimize the required user input to a system. Moreover, there is a long felt need in the art for system and technology that add more layer of cognitive processing in real-time improving people's intelligence and merge to A.I. Further, there is a long felt need in the art for system and technology that minimize people's need for studying and training in order to acquire knowledge. Finally, there is a long felt need in the art for system and technology that takes a user-centric perspective to help users and apply and a unique and non-invasive approach to improve people's cognitive function.

The subject matter disclosed and claimed herein, in one embodiment thereof, comprises a computer implemented method performed by a processor comprising the steps of reading an image or any other media content displayed on a display screen or received from a camera, generating a text stream from the said image or said any other media content, classifying the generated text using an optimized regular expressions algorithm for generating a user interface, learning user input, executing the user input if the user input predictions are accurate, organizing device-to-device communication, and displaying the classified information on the generated user interface.

### SUMMARY

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a computer implemented method performed by a processor comprising the steps of reading an image or any other media content displayed on a display screen or received from a camera, generating a text stream from the said image or said any other media content, classifying the generated text using an optimized regular expressions algorithm for generating a user interface on top of the visualized image, learning user input, executing the user input if the user input predictions are accurate, organizing device-to-device communication, and displaying the classified information on the generated user interface.

The key concept of the present invention is that the present invention implementation takes screenshots of the image displayed by itself and extracts text information from the image. The invention gives an electronic device such as a smartphone, laptop or the like in which the present invention is installed gives the device a unique reflection capacity that was not possible in the past and enable us to perform new computations that were not possible, an example could be to find a worker who does similar work to another worker for very specific tasks. The present invention uses a novel combination of computer vision, augmented reality, and artificial intelligence wherein each component is executed as instructions stored in computer memory.

The computer vision component reads image and generates an accurate depiction in a text parallel stream. The artificial intelligence component processes text generated by the computer vision component and performs classification using an optimized regular expressions algorithm for generating a user interface. The artificial intelligence component further performs learning of user input and executing user input if the user input predictions are accurate. Moreover, the artificial intelligence component organizes device to device communication for sharing information. The augmented reality component displays information generated by the artificial intelligence component on the generated user interface.

The system of the present invention is implemented in a simple computer and it works conceptually like a virtual transparent glass that understands and depicts the elements behind the glass while generating user interfaces in real-time displayed on top of the glass and predicting use input which in the case of a computer is mostly filling forms.

The present invention has an object detection API to detect real world objects which makes forms to be filled conceptually obsolete, but if it reads that there is a form it automates user input by learning past user input, learns source and decision-making process. The invention further auto fills form based on the accurately predicted user input and also frame queries. A dynamic user interface is generated in real-time and the objects detected by object detection API are displayed on a virtual glass.

The combination of the computer vision, augmented reality, and artificial intelligence of the present invention in the form of computer enabled instructions can run almost in every device and operating system natively with outstanding scripting productivity and C/C++ libraries linked to Python for the high processing.

The processing to display information is secure and optimally does not require any server. In one embodiment, an Optical Character Recognition (OCR) such as Tesseract OCR may be used for extracting information from an image.

In one embodiment of the present invention, “information requesting” forms are either autocompleted with the information learnt from the user input itself in previous forms or internal notes. Relevant information can be retrieved from the screenshots.

The technology of the present invention provides a unique and non-invasive approach to improve people's cognitive function and is very useful for people with cognitive disabilities. The technology further enables a is able to be self-aware in functions irrespective of the type of software being executed and all its complexity, and at the same time learning from the user.

The teachings of the invention provided herein can be applied to other systems, not necessarily the system described above. The elements and acts of the various examples described above can be combined to provide further implementations of the invention. Some alternative implementations of the invention may include not only additional elements to those implementations noted above, but also may include fewer elements.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a high-level block diagram showing essential components of the computer implemented cognitive functioning system of the present invention in accordance with an aspect of the present invention;

FIG. 2 illustrates a flow diagram showing exemplary steps performed by the computer implemented cognitive functioning system of the present invention in accordance with an aspect of the present invention;

FIG. 3 illustrates a flow diagram showing steps of providing a notification and action item by the computer implemented cognitive functioning system of the present invention to a user based on any input image or video in accordance with an aspect of the present invention;

FIG. 4 illustrates use of computer implemented cognitive functioning system of the present invention for displaying a user interface based on the parsed information from an image of a customer email to provide relevant information and text to a user;

FIG. 5 illustrates a perspective view showing use of the technology of present invention on a computer and on a smartphone with a camera as per the present embodiment;

FIG. 6 illustrates a flow diagram showing how tool of the present invention deals with existing forms from a user's previous input;

FIG. 7 depicts an abstraction model for designing the cognitive extension utilizing a subjective artificial intelligence approach according to the present invention;

FIG. 8 depicts an exemplary scenario depicting the operation of the cognitive functioning system of the present invention;

FIG. 9 depicts another exemplary scenario of a form that could be auto filled using the cognitive functioning system of the present invention; and

FIG. 10 depicts an information flow diagram of the cognitive functioning system of the present invention.

### DETAILED DESCRIPTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there is a long felt need in the art for system and technology that detect information from the real world and enable automation. There is also a long felt need in the art for system and technology that make the concept of software integrations obsolete. Additionally, there is a long felt need in the art for system and technology that minimize the required user input to a system. Moreover, there is a long felt need in the art for system and technology that add more layer of cognitive processing in real-time improving people's intelligence and merge to A.I. Further, there is a long felt need in the art for system and technology that minimize people's need for studying and training in order to acquire knowledge. Finally, there is a long felt need in the art for system and technology that takes a user-centric perspective to help users and apply and a unique and non-invasive approach to improve people's cognitive function.

The present invention, in one exemplary embodiment, is a computer implemented method performed by a processor comprising the steps of reading an image or any other media content displayed on a display screen or received from a camera, generating a text stream from the said image or said any other media content, classifying the generated text using an optimized regular expressions algorithm for generating a user interface, learning user input, executing the user input if the user input predictions are accurate, organizing device-to-device communication, and displaying the classified information on the generated user interface.

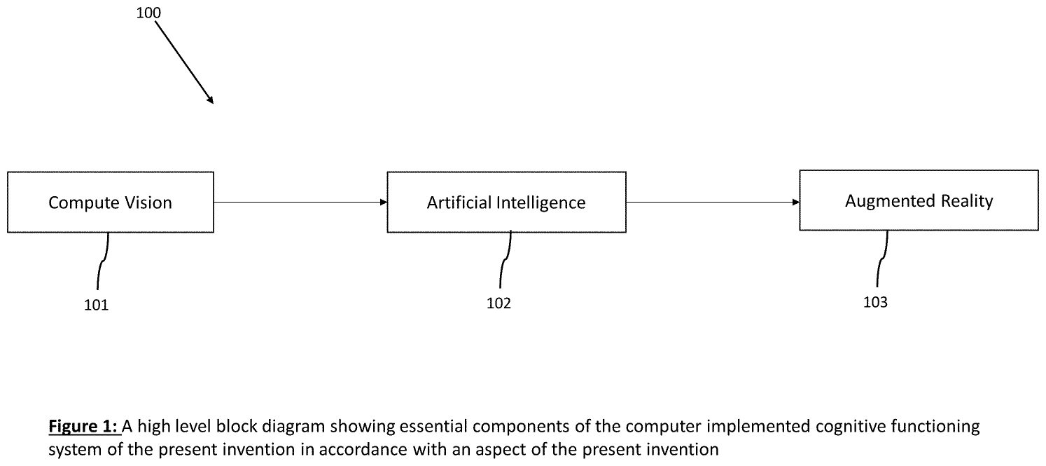

Referring initially to the drawings, FIG. 1 illustrates a high level block diagram showing essential components of the computer implemented cognitive functioning system of the present invention in accordance with an aspect of the present invention. The computer implemented cognitive functioning system 100 of the present invention comprises a computer vision component 101 that reads an image from an input such as a camera, video, or present on a display device and generates an accurate text stream to provide an accurate depiction of the input image. In practice, a user may capture an image using camera of a smartphone in which the system of the present invention is installed and the description of the image may he outputted by the computer vision component 101.

An artificial intelligence component 102 learns user input, such as name, address, phone number, zip code, state, file name, and/or any other data, corresponds to which fields on any given web form. The AI component 102 processes text input from the computer vision text stream and classify text using an optimized regular expressions algorithm for generating a user interface. Additionally, AI component organizes Device to Device communication for sharing information using an open-source protocol such as a chat-protocol. The AI component 102 also executes user input if the user input predictions are accurate.

In one embodiment, for learning user input, training user data consist of correct input and output features. This data can be given as input to the training algorithm of AI component 102. The algorithm may he provided by any one of the machine learning techniques that create a neural network, maximum entropy model, decision tree. Naïve Bayes model, any linear separator, support vector machines, etc.

The last component of the system 100 is augmented reality component 101. The AR component 103 displays information on a virtual transparent surface and renders user interfaces according to AI component 102 information.

The system 100 conceptually provides a virtual transparent glass over the content displayed on a display such as an email on a screen, a captured picture on a smartphone touchscreen. The system 100 understands and depicts the elements behind the virtual transparent glass while generating user interfaces in real-time displayed on top of the glass to assist a user.

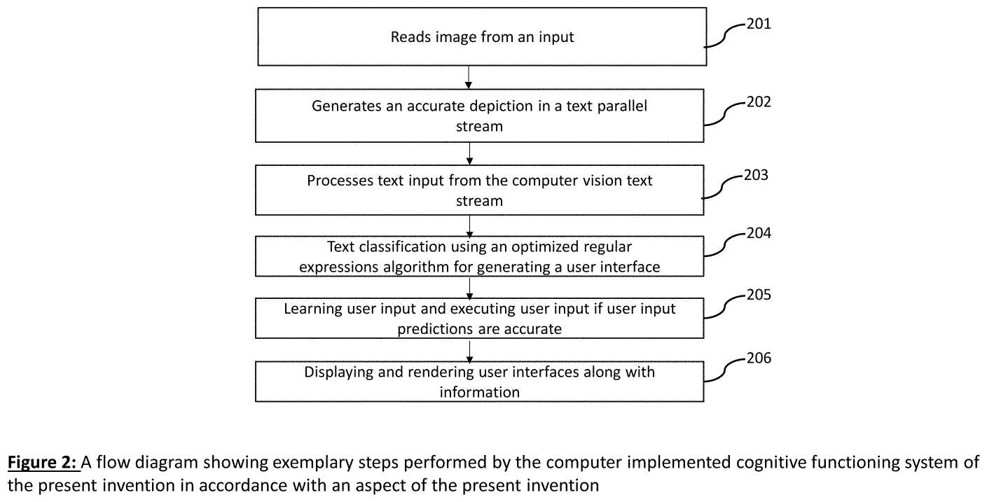

FIG. 2 illustrates a flow diagram showing exemplary steps performed by the computer implemented cognitive functioning system of the present invention in accordance with an aspect of the present invention. The cognitive functioning system of the present invention is stored in a computer readable medium and may cause the processor of the device in which the cognitive functioning system to execute a plurality of stored instructions. Initially, an image is read from an input (Block 201). Then, an accurate depiction in a text stream is generated by the system (Block 202). The text stream is also referred to as the computer vision text stream. Thereafter, text input from the computer vision text stream is processed by the system (Block 203). Classification of the text is performed using an optimized regular expression algorithm for generating a user interface (Block 204). One or more user interfaces may be generated by the system after classification of the text. An important function of the system of the present invention to provide cognitive functioning is to learn user input and executing user input if predictions based on learning are accurate (Block 205). Finally, the correctly predicted input are displayed on the rendered user interfaces (Block 206).

Additionally, the system also organizes Device to Device communication for sharing information (key/value form pairs) and processes form keys.

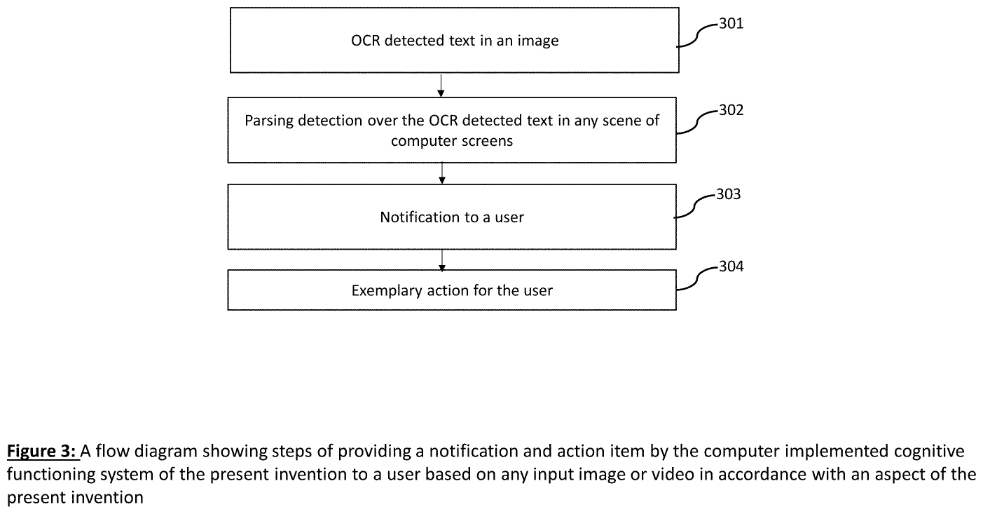

FIG. 3 illustrates a flow diagram showing steps of providing a notification and action item by the computer implemented cognitive functioning system of the present invention to a user based on any input image or video in accordance with an aspect of the present invention. As shown, in an input image, text is detected using an OCR component which can be a part of the computer vision component 101 of the system 100. In the present embodiment, Tesseract OCR may be used (Block 301). On the OCR text, parsing is performed and it should be appreciated that the parsing is performed in any scene, image, video or frame present on a display such as display of a computer screen, a smartphone or the like (Block 302). Based on the parsing, a user interface is generated and a notification is generated based on the parsed data and learned user input (Block 303). Based on the notification, if an action item is recommended for a user, then the system provides the action item to the user (Block 304).

As an example, the system or the computer implemented application 100 of the present invention may notify a user of the location of keys when asked by a user using voice command. The technology of the present invention learns the last location and time of capturing the keys via camera of the smartphone in which the technology/system/application is installed. The user is notified of the location and time of the last captured correct keys.

It should be appreciated that the present invention is device agnostic and may run on any electronic device and operating system. The system/application may work with voice commands or any input device. The application is extended using addons which are installed by the users from its specific AppStore and implemented by companies and individuals who wish to improve their conversions by speeding up the user interaction vs web and mobile apps and reducing the amount of input to operate. An Add-On for this platform is defined by the set of objects of interest in a scene, or a combination of objects of the current and past scenes, and information learnt from previous input and one action to be executed as a response. The application may be available as plug-in for a browser application and may be used to learn bank cards of a user to assist the user login to bank website and system.

In order to improve learning and efficiency of the system, the present invention may easily integrate with cognitive engines such as AWS Amazon Rekognition, Microsoft Azure, and Google Cloud cognitive services. In the preferred embodiment, local cognitive processing on the device in which the technology of the present invention is used is developed and no distributed or central server is used. However, it should be appreciated that a central or distributed server may be used to implement cognitive services of the present invention but for privacy aspects and performance the best is that the device itself processes all input sources.

The present invention provides a unique and non-invasive approach to improve people's cognitive function and is useful for people with cognitive disabilities. The present invention does not use third-party servers. Data does not leave the device and is not stored in any server. Communication between devices with installed application of the present invention uses any of the known open-source chat-protocol using end-to-end encryption.

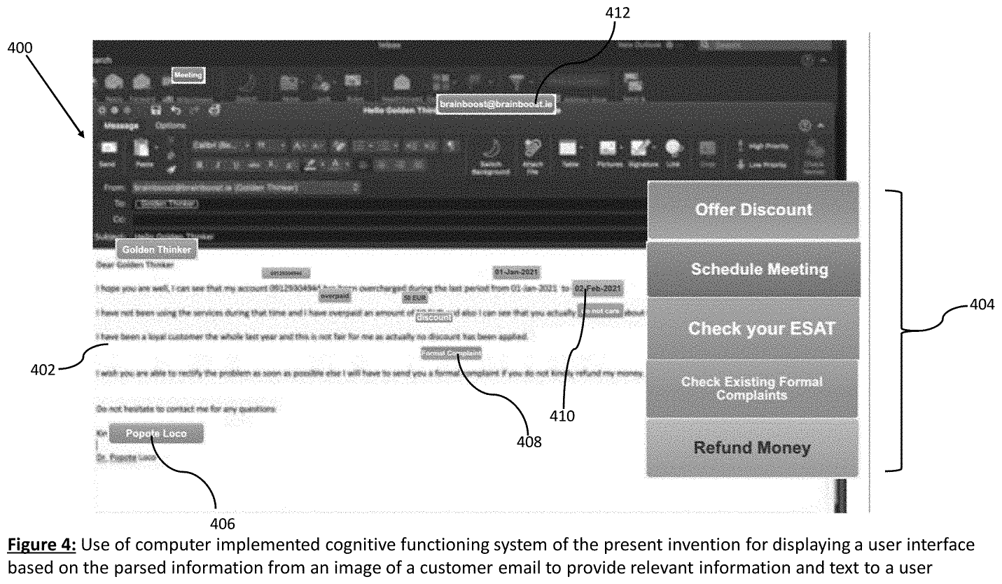

FIG. 4 illustrates use of computer implemented cognitive functioning system of the present invention for displaying a user interface based on the parsed information from an image of a customer email to provide relevant information and text to a user. As shown, a screenshot of an email 400 is provided as an input to the system of the present invention. A virtual transparent glass appears over the screenshot of the email 400 and important parsed information such as name of the customer 406, important keywords such as one or more dates 410, complaint 408, email ID of the customer 412 and other relevant information is displayed on the virtual transparent display along with some notifications or action items 404 based on the parsed information. By parsing the text of the OCR of the image 402, one or more action items such as offer discount, schedule meeting, check ESAT, check existing formal complaints or refund money may be shown to a user.

It should be appreciated that the level of information displayed on the virtual transparent glass may vary based on the OCR information. The information may be auto filled in the subsequent process thus reducing the time and effort of the user to input information. For convenience of a user, similar data may be color coded in same color and action items for the data or information may also be encoded in the same color. The parsed data is auto filled whenever required and is not need to be input manually.

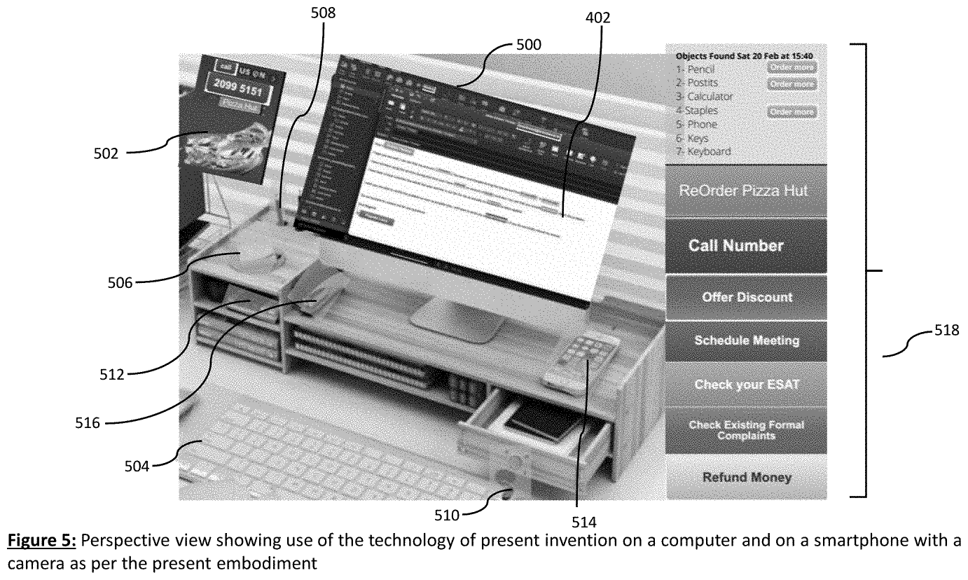

FIG. 5 illustrates a perspective view showing use of the technology of present invention on a computer and on a smartphone with a camera as per the present embodiment. As shown, in the present embodiment, system of the present invention installed in a computer processes the image displayed on the display surface of the computer. Using the computer 500, the screenshot 402 of an email is parsed. Simultaneously, using a smartphone camera (not shown), a plurality of items placed on a table are scanned and the application/system of the present invention installed in the smartphone displays the user interface on virtual transparent glass to show all necessary and learned information. As shown, a pizza paper 502, sticky notes 506, keyboard 504, pen 508, keys 510, calculator 512, phone 514, and stapler 516 are identified, shown and parsed by the application. Also, for each item, an action plan 518 is shown to the user to perform one or more actions such as ordering a pencil, reordering a pizza, ordering staples etc.

It should be appreciated that the present invention can learn new input and train using artificial intelligence component and may be displayed in an augmented reality display.

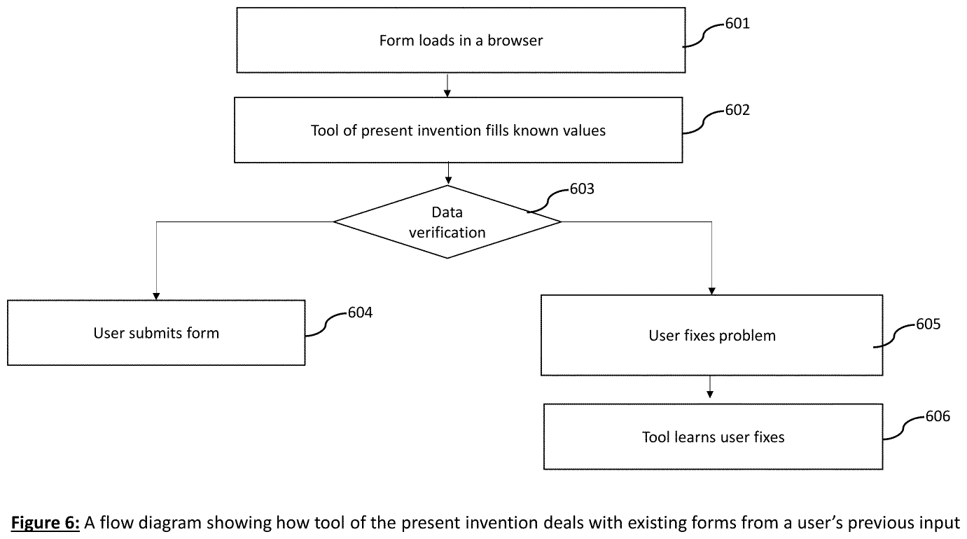

FIG. 6 illustrates a flow diagram showing how tool of the present invention deals with existing forms from a user's previous input. Initially, a form is loaded in a browser (Block 601). Then, tool of the present invention auto-fills known values in the loaded form (Block 602). A verification of auto-filled data is performed (Block 603) and if the data is correct, then, user may submit the form (Block 604). Else, the user may correct the information (Block 605) and the tool automatically learns the fixes made by the user and learns not to insert the incorrect data into the form (Block 606).

The tool of the present invention keeps learning the new values and replace them in auto-filling of the data every subsequent time to improve the efficiency and utility.

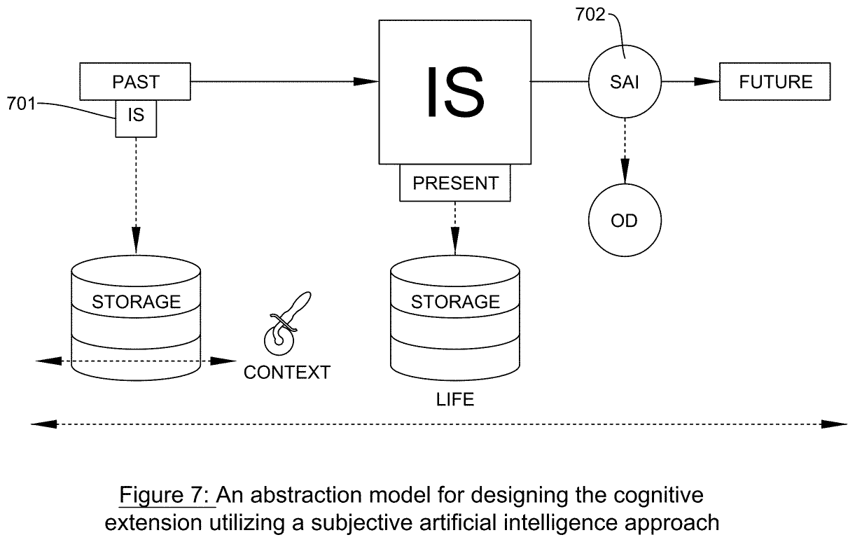

FIG. 7 depicts an abstraction model for designing the cognitive extension system utilizing a subjective artificial intelligence approach according to the present invention. The proposed invention utilizes a combination of three existing technologies, augmented reality, computer vision, and artificial intelligence. The cognitive extension system enables the user to get instant responses to the query based on the continuous monitoring of the users past activities, responses, habits, etc. The proposed system of the invention ease the work of the user by keeping every response ready. The system comprise an input source 701, a subjective artificial intelligence 702 and an output device 703. The input source 701 is the virtual transparent glass. The virtual transparent glass has its own intelligence which translates the light into a depiction and interpretation of what is being seen into parseable text by integrating computer vision algorithms. Further, the virtual transparent glass may be configured to transmit light to a subjective artificial intelligence 702. The subjective artificial intelligence 702 is configured to interpret this information and return an output which is interpreted by a set of regular expressions on the output device 703. The output device 703 can be a computer/tablet/mobile. The interpreted set of regular expressions are translated into the user interface in real time over the “conceptual glass” or augmented reality device, for a specific purpose or a physical action to be taken by another device or object (such as the Internet of Things). Moreover generating a real time tangible improvements not only to a virtual world, but also to our physical world that is the one that supports our life.

For example, a police officer is wearing the transparent glasses and walking on the street to check for defaulters. The proposed system will enable the police officer to look around, and if some car did not pay the parking, he will see a red balloon on top. The system uses augmented reality to enables the police office to see that is not present in reality but is the result of learning the past input/query and displaying an output.

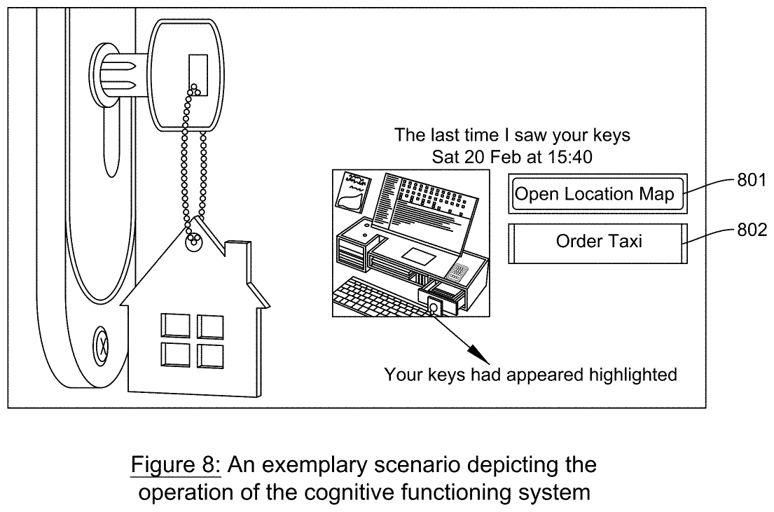

FIG. 8 depicts an exemplary scenario depicting the operation of the cognitive functioning system. In the exemplary scenario, the user is wearing the augmented reality glasses all the time and you do not remember where you left your keys. According to the proposed invention the system will have recorded that the keys are in a shelf, as the computer vision will have recorded at a certain time the image of yourself leaving the keys there, and saved that information into text. So on asking the where did I put the keys? The system will be able to show you a small picture saying where they are and the image will be timestamped included. The system will also display buttons that will be, book a taxi button 801 and open location map button 802. If the user clicks on the book a taxi button 801 then the system will automatically book a taxi for you, and if the user clicks the open location map button 802 then the system will open maps and starts navigation the directions to the home.

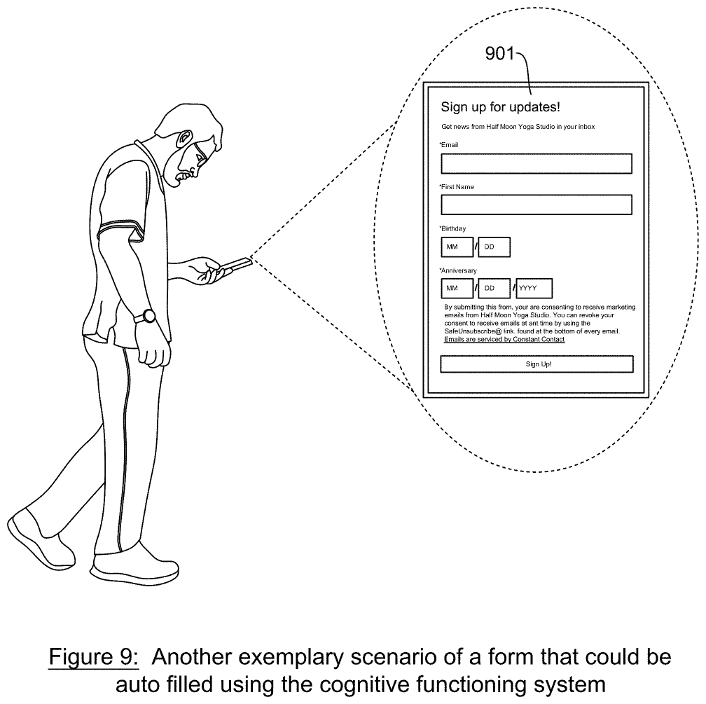

FIG. 9 depicts another exemplary scenario of a form 901 that could be auto filled using the cognitive functioning system of the present invention. In another exemplary scenario, the user is wearing the augmented reality glasses and is continuously looking at a form 901 (as shown). As the glasses are already integrated a camera with a computer vision the user could actually be able to fill forms, just by looking at them. The computer vision will be able to recognize that you are looking at a phone/computer/table, and that the device is displaying a form 901 upon a user interface which let's say requires email, name, birthday and a password. The augmented reality glasses will then trigger the instructions for the forms to be filled with the information that the system knows about the user as the user have filled that information previously once upon a time.

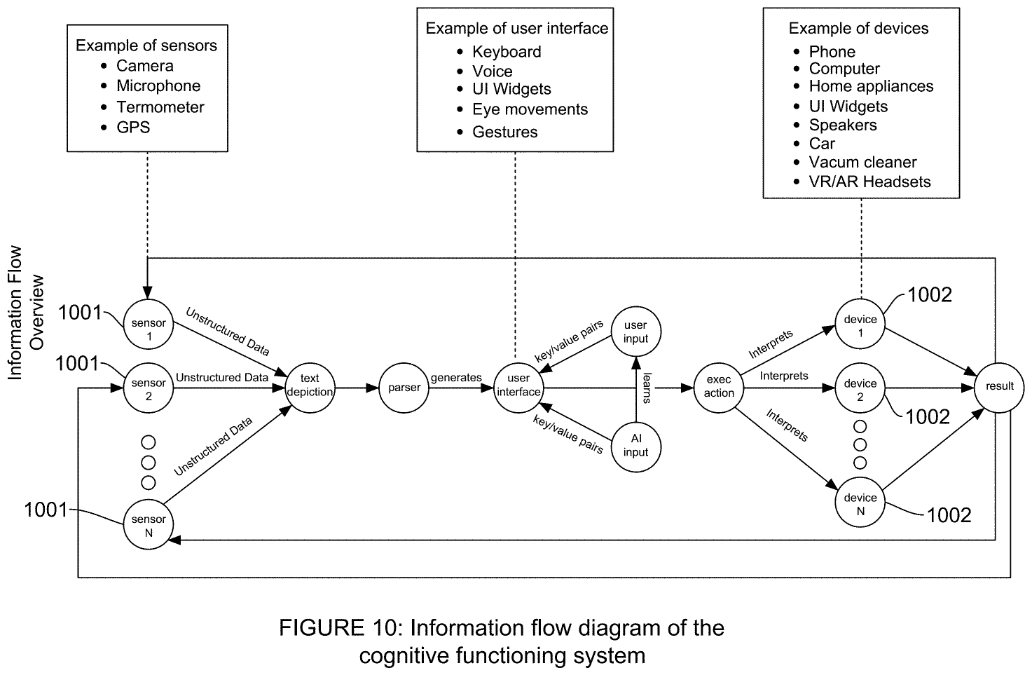

FIG. 10 depicts an information flow diagram of the cognitive functioning system of the present invention. The cognitive functioning system 100 receives information/data from all sorts of sensors 1001 to name a few, camera, thermometer, microphone, GPS and so forth. The sensors 1001 mentioned above along with other sensors 1001 transmit unstructured data. The unstructured data may be media, imaging, audio, sensor data, text data received from various types of sensors 1001. The unstructured data is then parsed into a useful format. The parsed data may generate a user interface. The user interface can be keyboard, voice, UI widgets, eye movement, gestures. The cognitive functioning system 100 learns user inputs as well as AI inputs to execute an action. The action may be interpreted by various device 1002 available in vicinity of the user. The device may be, phone, computer, fan, chair, home appliances, UI widgets, speakers, car, vacuum cleaner, VR/AR headsets etc.

In an exemplary scenario, if a user step into an office and all objects around the user act together in order to serve the user in a better manner. Actions like the chairs walking themselves before you sit, and/or auto filling of a form that appeared in an old device such as tablets or personal computers if the user point his vision towards it. Every system work together to serve the user in a coordinated way without even being integrated as every system will be able to receive preemptive input according the context.

In another exemplary scenario, if the user points his vision towards something dirty a vacuum cleaner cleans it because the user did it a few times in the past in a similar context with no need to input any parameters as the vacuum cleaner has the knowledge of yourself controlling it in the past.

In yet another exemplary scenario, if the user is painting a wall, and be able to transfer the knowledge into a machine that mimics the user doing the same task that will paint much more similar walls as you did by learning from our own subjective experience.

Many examples can be quoted of the cognitive functioning system 100 that fully adapts to our needs before you even think.

Aspects of the invention may be stored or distributed on computer-readable storage media, including magnetically or optically readable computer discs, hard-wired or preprogrammed chips (e.g., EEPROM semiconductor chips), or other data storage media. Alternatively, computer implemented instructions, data structures, and other data under aspects of the invention may be distributed over the Internet or over other networks, on a propagated signal on a computer-readable propagation medium or a computer-readable transmission medium. Non-transitory computer-readable media include tangible media such as hard drives, CD-ROMs, DVD-ROMS, and memories such as ROM, RAM, and Compact Flash memories that can store instructions and other computer-readable storage media. Transitory computer-readable media include signals on a carrier wave such as an optical or electrical carrier wave and do not include hardware devices.

The application/software/system of the present invention amplifies a person's mind capabilities enabling him to solve problems faster and acting as a cognitive support in everyday life. The software acts upon the person's problem.

The present invention eliminates forms and uses knowledge hooks (defined as a set of regular expressions and an action) which are regularly updated by learning user input and other relevant information using the artificial intelligence component.

The computer implemented cognitive functioning system is external to any other system or device and is able to work with information from multiple sources and systems without dealing with their huge internal complexity. Due to the portable nature of the system of the present invention, a user can run the technology/application on a computer, a tablet, laptop, phone, or any other electronic device. The present invention uses a merged variant of Computer Vision, Augmented Reality, and Artificial Intelligence.

The virtual glass implementation of the present invention can be ported to basically almost every device including mobiles. The invention provides outstanding scripting productivity and C/C++ libraries linked to Python for the high processing consuming of information.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “computer implemented cognitive functioning system”, “virtual glass implementation”, and “application/software/system” are interchangeable and refer to the computer implemented cognitive functioning system 100 of the present invention.

Notwithstanding the foregoing, the computer implemented cognitive functioning system 100 of the present invention can include any additional component to enhance the functionality and efficiency of the computer implemented cognitive functioning system 100. One of ordinary skill in the art will appreciate that the configuration, components of the computer implemented cognitive functioning system 100 as shown in the FIGS. are for illustrative purposes only and that many other configurations and components are well within the scope of the present disclosure.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A non-transitory computer-readable medium storing executable instructions that, when executed, cause at least one processor to perform operations comprising:
reading an input image;
generating a parallel text stream indicating an accurate description of the image;
generating a user interface using an optimized regular expressions algorithm;
learning user input and executing accurately predicted user input; and
displaying generated information on the user interface.

2. A system to generate user interfaces in real-time and acts as on a transparent virtual glass surface, the system comprising:
at least one processor; and
a non-transitory computer-readable medium storing executable instructions that when executed, cause at least one processor to perform operations comprising:
detecting an image or video and generating text stream of the image or video;
learning user input and auto-filling forms using the learned user input;
generating a dynamic user interface in real-time; and
displaying the generated user interface on the transparent virtual glass surface.

3. The system of claim 2, further comprises the processor performing a device-to-device communication.

4. The device-to-device communication of claim 3, further uses a chat protocol.

5. The system of claim 2, further automates a task according to previous user input and the previous context in which the user gave the input.

6. The system of claim 2, is further implemented in a smartphone.

7. The system of claim 2, is further implemented as a plug-in in a browser.

8. The system of claim 2, further uses the camera of a smartphone to capture and learn images.

9. A non-transitory computer-readable medium storing executable instructions that, when executed, cause at least one processor to perform operations comprising:
extracting information from an image;
learning user inputs;
auto-completing forms or text boxes;
generating a dynamic user interface in real-time; and
displaying the generated user interface.

10. The method of claim 9, further extracts information from an image using computer vision.
